(19) United States
(12) Patent Application Publication
(10) Pub. No.: US 2005/0027889 A1
(43) Pub. Date: Feb. 3, 2005

(54) USB extender

(76) Inventor: Francisc Sandulescu, Bucurest (RO)

Correspondence Address: MARK C. JOHNSON;Renner, Otto, Boisselle & Sklar, LLP, Nineteenth Floor, 1621 Euclid Avenue, Cleveland, OH, 44115-2191, US

(21) Appl. No.: 10/687,120

(22) Filed: Oct. 16, 2003

Related U.S. Application Data
(60) Provisional application No. 60/491,389, filed on Jul. 31, 2003.

(51) Int. Cl. G06F 15/16

(52) U.S. Cl. 709/250

(57) ABSTRACT

The present invention relates to a system and method for extending USB connections. Provided are both active USB extenders and passive USB extenders that include functionality for accepting both standard and/or non-standard USB commands. The passive extender functions on a USB communications channel and the active extender functions to extend USB communications over a non-USB communications channel. Both types of extenders are configured to handle non-standard USB commands, such as a Macintosh power-on command or a Sun Microsystems reset, suspend, or wake-up command.

### FIELD OF THE INVENTION

The present invention relates to Universal Serial Bus (USB) communication standards and, more specifically, to a system and method for extending USB connections.

### BACKGROUND OF THE INVENTION

Universal Serial Bus is a peripheral bus standard developed by the PC and telecom industry, including Compaq, DBC, IBM, Intel, Microsoft, NEC and Northern Telecom. USB defines a bus and protocols for the connection of computer peripherals to computers (and computers to each other). “Universal Serial Bus Specification,” Compaq, Intel, Microsoft, NEC, Revision 1.1, Sep. 23, 1998, describes USB and its implementation and is incorporated herein by reference. Proposed and actual USB devices include keyboards, mice, telephones, digital cameras, modems, digital joysticks, CD-ROM drives, tape and floppy drives, digital scanners, printers, MPEG-2 video-base products, data digitizers and other relatively low bandwidth devices—USB version 1.x supports data rates of up to 12 Mbits/sec. Newer versions of the standard (e.g., USB 2.0) contemplate higher data rates.

USB supports the dynamic insertion and removal of devices from the bus (or “hot-plugging”) and recognizes actual peripherals or functions hosts (typically a computer); and hubs, which are intermediate nodes in the network that allow the attachment of multiple upstream hubs or functions. Upon insertion of an upstream hub or function, the host/hub on the downstream side of the bus initiates a bus enumeration to identify and configure the new device. Upon removal, the removed device is “forgotten.”

Due to the stringent electrical signal requirements of USB standard specifications, it is difficult to meet the electrical specifications for USB signaling using simple amplifiers or special cable. Accordingly, a USB cable longer than about 5-10 meters generally will not work, even when using active terminations. In part, extending USB cables beyond about 5-10 meters is difficult because signal symmetry and skew can become compromised. It would be preferable if USB devices could be connected by a technology that permits the devices to be more than about 5-10 meters from a host.

One method of increasing the distances between a USB device and a host is to use signal translation to convert USB signals into an alternate signal capable of traveling more than 10 meters without distortion. Unfortunately, even if a USB signal is translated such that the electrical specifications are met, the USB timing specifications may limit the length of the extender to about 50-80 meters. According to USB 1.x standards, answers to messages originating from a host must be received within about 1333 nanoseconds (ns) or the host will generate an error. The 1333 ns includes the time required for the message to travel from the host to the peripheral device (referred to as the host to device trip time); the time required for the device to answer the host; and the time required for the message to travel from the device to host (referred to as the device to host trip time). Also according to USB 1.x standards, the trip time (host to device and/or device to host) is specified to be not longer than about 380 ns.

Therefore, one can calculate the length of an extender to be about 126 meters in an ideal case where there is no time required for the device to answer the host and where the cable transmits data at the speed of light. Typically, circuitry introduces delay of about 100 ns and the signal speed for common cables is about 1 meter per 5 ns, compared to the speed of light which is about 1 meter per 3 ns. Thus, for a “transparent” USB extender (referring to an extender that merely translates or converts signals from USB-type signals to another type of signal and back to USB-type signals) one can calculate a maximum limit of about 55 meters.

To extend USB signals beyond this calculated limit (about 55 meters), a different type of USB extender may be required. In order to prevent the generation of an error by the host due to response delay, a USB extender can be configured to immediately answer the host with a “not acknowledge” (NAK) response while sending the message to the device and awaiting the device's response. Upon receipt of the NAK response, the host will retry the original message about one millisecond later. When the host attempts to send the message again, the answer (from the device) may have been received by the extender and be immediately available for delivery to the host. While this type of USB extender allows for longer extensions, it decreases the available bandwidth, it is not transparent, and its implementation in both hardware and software is complex. Further, some USB devices and/or host drivers may not work with this type of extender.

Further complicating USB extender device technology, some manufacturers are using modified versions of USB protocol. For example, Macintosh (Mac) computers have a special signaling on the USB lines when the computer is turned off to permit starting the computer via a button disposed on the Mac keyboard. This feature is not supported by standard USB hubs. Similarly, pressing a key on the keyboard may not wake up a SUN computer from sleep mode if the keyboard is connected through a hub.

In addition to standard USB devices and technologies, a new USB standard 2.x now exists. “Universal Serial Bus Specification,” Compaq, Hewlett-Packard, Intel, Lucent, Microsoft, NEC, Philips, Revision 2.0, Apr. 27, 2000 describes the most current USB 2.x standard and its implementation and is incorporated herein by reference. The USB 2.x standard permits faster data transmission than the USB 1.x standard. Many of the same challenges encountered when trying to extend USB 1.x devices exist with USB 2.x devices.

For example, the initiation of high-speed hand shaking with the host and the detection of the answer from the host with 2.x type extenders can be problematic, as can answering the handshaking initiated by the USB 2.x device. When the extender is configured for multiple USB devices, it should also preferably be capable of detecting the direction of each message and transmitting the message in the proper direction.

In addition to these main functions, the extender has to handle all other USB 2.x bus signaling states (reset, suspend, wake-up) and modified versions of USB protocols correctly. Also, it would be desirable for the extender to work correctly with full-speed devices/hosts. Further, it would be preferable to extend both USB 1.x and USB 2.x devices beyond the standard cable length limits of about 5 meters while maintaining compatibility with modified versions of USB technologies.

### BRIEF SUMMARY OF THE INVENTION

According to an aspect of the invention, there is provided a USB extender for extending the distance between a host and a device. The USB extender includes: a controller; a host transceiver connectable to a USB host and configured to transmit to the USB host both standard USB commands and non-standard USB commands received from the controller; and a device transceiver connectable to a USB device and configured to receive both standard USB commands and non-standard USB commands from the USB device and to transmit the received USB commands to the controller; wherein the controller is configured to determine the nature of the USB commands received at the device transceiver and to transmit determined commands to the host transceiver.

According to another aspect of the invention, a USB extender for extending the distance between a host and a device is provided. The USB extender includes: a host unit connectable to a USB host and configured to transmit to the host both standard USB commands and non-standard USB commands received from a device unit via a non-USB communications channel; a device unit connectable to a USB device and configured to receive both standard USB commands and non-standard USB commands from the USB device and transmit the received commands to the host unit via the non-USB communications channel; and a non-USB communications channel between the host unit and the device unit.

According to another aspect of the invention, a method for extending the distance between a host and a Mac keyboard device that uses non-standard USB commands is provided. The method includes: detecting the host power status by a host unit; maintaining a voltage from the host to the keyboard when the host is powered down; receiving a USB command from the keyboard at a USB extender device unit; determining the nature of the command; coupling the maintained voltage to ground upon determining that the host is powered down and the received command is a Mac power-on command; transmitting the received USB command from the USB extender device unit over a non-USB communications channel to a USB extender host unit; and transmitting the USB command received at the USB extender host unit to the host over a USB communications channel.

### BRIEF DESCRIPTION OF THE DRAWINGS

FIG. 1 is a block diagram of a system with a passive type USB extender;

FIG. 2A is a block diagram of a system with an active type USB extender;

FIG. 2B is a block diagram of the host unit 204 of FIG. 2A;

FIG. 2C is a block diagram of the device unit 206 of FIG. 2A;

FIG. 3 is a schematic diagram of an exemplary embodiment of a host unit 204 implementing Mac functionality;

FIG. 4 is a schematic diagram of an exemplary embodiment of a device unit 206 implementing Mac functionality; and

FIG. 5 is a flow chart generally illustrating an aspect of extending the distance between a Mac host and a Mac keyboard device that uses non-standard USB commands.

### DETAILED DESCRIPTION OF THE INVENTION

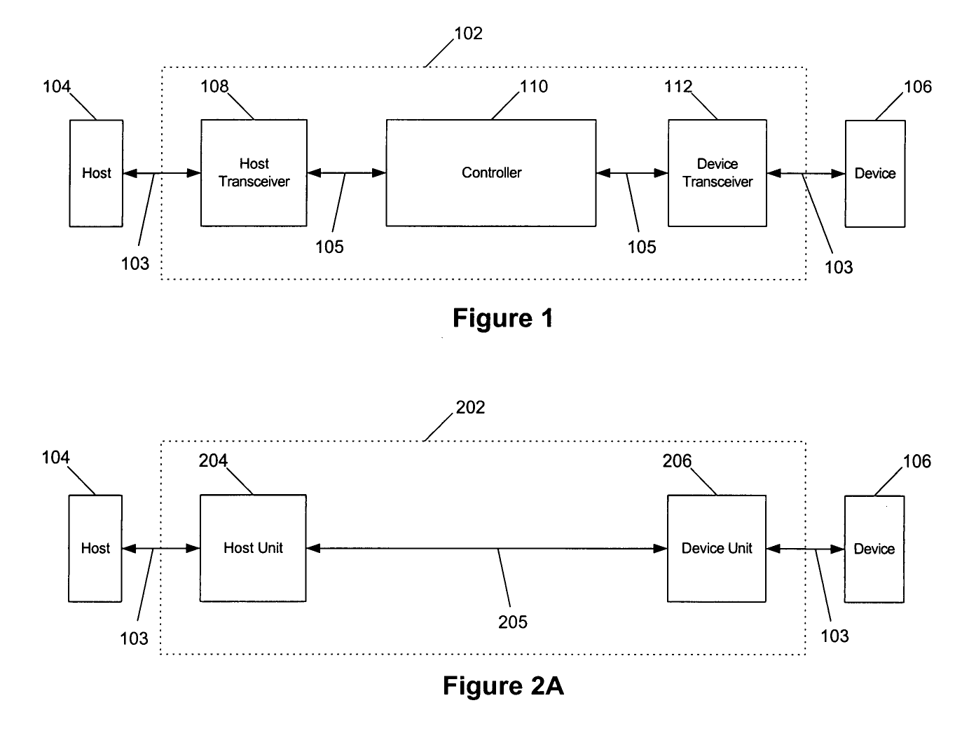

Turning initially to FIG. 1, a block diagram of a system with a passive type USB extender is illustrated. The USB extender 102 is generally positioned between a USB host 104 and a USB device 106. The USB host 104 can be any USB host and can be configured to function in USB 1.x systems, USB 2.x systems, or both. Likewise, the USB device 106 can be any USB device, such as a keyboard, mouse, printer, scanner, digital camera, digital audio player, external drive, etc. and can be configured to function in USB 1.x systems, USB 2.x systems, or both. Like the host 104 and device 106, the extender 102 can be configured to function in USB 1.x systems, USB 2.x systems, or both.

The host 104 and device 106 may be configured to utilize both standard and non-standard USB commands. Standard USB commands are those commands defined in either the of USB specifications. Non-standard commands may be any other command sent from host 104 to device 106 or from device 106 to host 104. For example, Mac computer systems have a power button disposed on the keyboard. If the device 106 is a Mac keyboard, the pressing of the power button disposed on the Mac keyboard would be a non-standard USB command. When the Mac host 104 is powered down, meaning that it entered a lower power mode, a voltage of about 0.7V to about 1V is maintained from the Mac host 104 to the Mac keyboard 106. By pressing the power button, the maintained voltage circuit is shorted, thereby causing the Mac host 104 to power up. Therefore, in order to implement a USB extender 102 for a Mac keyboard 106 and host 104, the functionality of the power button disposed on the Mac keyboard 106 is preferably maintained.

Other manufacturers of hosts 104 and devices 106 have non-standard commands. Sun Microsystems, for example, utilizes non-standard reset, wake-up, and suspend commands. Thus, in order to implement a USB extender 102 for Sun Microsystems systems, both the standard and non-standard USB commands are preferably passed between the host 104 and the device 106.

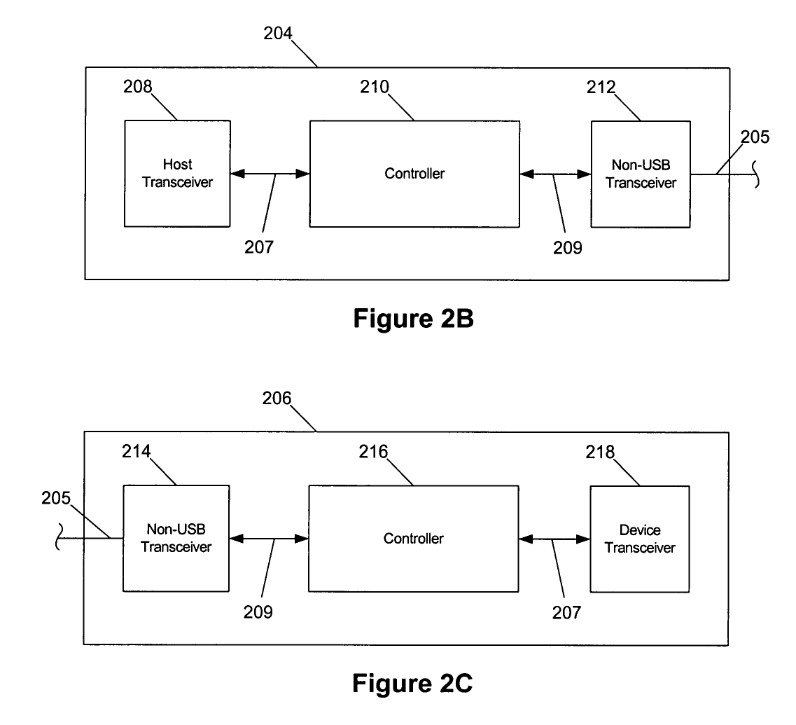

USB extenders can be “passive” type extenders that function like amplifiers of the USB signal. A “passive” type extender is depicted in FIG. 1 and functions to amplify and reshape the USB signal to compensate for increased distances. USB extenders can also be “active” type extenders that function to convert the USB signal into another form capable of crossing greater distances than a USB signal. An “active” type extender is depicted in FIG. 2.

Whether an extender is a 1.x extender or a 2.x extender, a “passive” or an “active” extender, it preferably includes basic functionality to permit the passage of standard USB commands over extended distances. With all types of extenders, hand-shaking and message transfer typically is addressed as design considerations. An extender should initiate hand shaking with a host and detect answers from the host. The extender should also answer the hand-shaking initiated by the device. In other words, the USB extender should appear as the device to the host and as the host to the device. The extender should also be capable of detecting the direction of each USB message so that the message can be transmitted in the correct direction. In addition, the extender should be able to detect or determine the start and end of each message or command.

The extender 102 includes a host transceiver 108, a controller 110, and a device transceiver 112. Each of the host transceiver 108 and device transceiver 112 may be a circuit implementing the physical layer for the transmission protocol, such as a USB 2.0 PHY or the like. The host transceiver 108 is connectable to a host 104 via a USB cable 103 and is configured to transmit to the host 104 both standard USB commands and/or non-standard USB commands received from the controller 110. The host transceiver 108 may be a “device type” transceiver in that to the host 104, it appears to be the device 106. The host transceiver 108 may also be configured to receive USB commands from the host 104 and to transmit the received commands to the controller 110.

The device transceiver 112 is connectable to a USB device 106 via USB cable 103, and configured to receive both standard USB commands and/or non-standard USB commands from the device 106 and to transmit the received USB commands to the controller 110. The device transceiver 112 may be a “host type” transceiver in that to the device 106, it appears to be the host 104. The device transceiver 112 may also be configured to transmit to the device 106 USB commands received from the controller 110.

The host transceiver 108 and the device transceiver 112 are each connected to the controller 110 by an interface 105, such as, for example, a transceiver macrocell interface like the USB 2.0 Transceiver Macrocell Interface (UTMI). The controller 110 may be a programmable circuit, such as a complex programmable logic device or the like. The controller 110 is configured to determine the nature of the USB commands received at the device transceiver 112 and to transmit the determined commands to the host transceiver 108. The controller 110 may also be configured to determine the nature of USB commands received at the host transceiver 108 and to transmit the determined commands to the device transceiver 112. When the controller 110 transmits commands to either the host transceiver 108 or the device transceiver 112, the controller 110 preferably performs signal amplifying and/or reshaping to compensate for the increased transmission path due to the extender. Further, the controller 110 also preferably determines the direction of each command or message so that the commands transmitted from the controller 110 are transmitted in the correct direction.

In one example embodiment, the extender 102 also includes circuitry for determining whether the host 104 is powered down. While the host 104 is powered down, the extender 102 can maintain a voltage of about 0.7V to about 1V. The extender also includes, in this embodiment, circuitry to determine if a power button on a Mac keyboard device 106 has been pressed. This circuitry may or may not be part of the controller 110. The extender 102 also includes circuitry for grounding, shunting, or shorting the maintained voltage circuit upon determining that the host 104 is powered down and the power button on the Mac keyboard device 106 has been pressed. An example implementation of this circuit will be described in greater detail below.

In one example embodiment, the extender 102 includes circuitry for implementing reset, suspend, and wake-up functions for a Sun Microsystems host 104 and device 106. Again, this circuitry may or may not be part of the controller 110.

Turning next to FIG. 2A, a block diagram of a system with an “active” type USB extender is illustrated. The extender 202 can be configured to function in USB 1.x systems, USB 2.x systems, or both. The extender 202 includes a host unit 204, a device unit 206, and a non-USB communications channel 205. The host unit 204 is connectable to the host 104 via a USB cable 103 and is configured to convert the non-USB commands received via the non-USB communications channel 205 and transmit to the host 104 the converted standard USB commands and/or non-standard USB. The host unit 204 may also be configured to receive standard and/or non-standard USB commands from the host 104, convert the received USB commands to non-USB commands, and transmit the converted non-USB commands to the device unit 206 via a non-USB communications channel 205.

The device unit 206 is connectable to a USB device 106 via USB cable 103 and is configured to receive both standard USB commands and/or non-standard USB commands from the USB device 106, convert the received commands to non-USB commands, and transmit the received commands to the host unit 204 via the non-USB communications channel 205. The device unit 206 may also be configured to receive non-USB commands from the host unit 204 via the non-communications channel 205, convert the received commands to standard and/or non-standard USB commands, and transmit the converted commands to the device 106.

The non-USB communications channel 205 may be any other type of communications channel, such as a wire-based category 5 (CAT5) communications channel or wireless communications channel. Such communication mechanisms include, for example, Ethernet, Token-Ring™, 802.11-type wireless data transmission, or other wire-based or wireless data communication mechanisms as will be apparent to one of ordinary skill in the art.

Turning next to FIG. 2B, a block diagram of the host unit 204 from FIG. 2A is illustrated. The host unit 204 includes a host transceiver 208, a controller 210, and a non-USB transceiver 212. Each of the host transceiver 208 and non-USB transceiver 212 may be a circuit implementing the physical layer for the transmission protocol. For example, the host transceiver 208 may be a USB 2.0 PHY or the like, while the non-USB transceiver may be an Ethernet PHY, or the like. The host transceiver 208 is connectable to a host 104 via a USB cable 103 and is configured to transmit to the host 104 standard USB commands and/or non-standard USB commands received from the controller 210. The host transceiver 208 may be a “device type” transceiver in that to the host 104, it appears to be the device 106. The host transceiver 208 may also be configured to receive standard and/or non-standard USB commands from the host 104 and to transmit the received commands to the controller 210.

The non-USB transceiver 212 is connectable to the device unit 206 via the non-USB communications channel 205. The non-USB transceiver is configured to receive non-USB commands from the device unit 206 via the non-USB communications channel 205 and transmit the received non-USB commands to the controller 210. The non-USB transceiver 212 may also be configured to receive non-USB commands from the controller 210 and transmit the received commands to the device unit 206 via the non-USB communications channel 205.

The host transceiver 208 and the non-USB transceiver 212 are each connected to the controller 210 by an interface. The interface 207 that connects the host transceiver 208 to the controller 210 may be, for example, a transceiver macrocell interface like the USB 2.0 Transceiver Macrocell Interface (UTMI). Similarly, the interface 209 that connects the non-USB transceiver 212 to the controller 210 may be, for example, one or both of a GigaBit Media Independent Interface (GMII) and a Ten Bit Interface (TBI).

The controller 210 may be a programmable circuit, such as a complex programmable logic device or the like. The controller 210 is configured to determine the nature of the non-USB commands received at the non-USB transceiver 212, to convert the non-USB commands to standard and/or non-standard USB commands, and to transmit the converted commands to the host transceiver 208. The controller 210 may also be configured to determine the nature of standard and/or non-standard USB commands received from the host transceiver 208, to convert the USB commands to non-USB commands, and to transmit the converted non-USB commands to the non-USB transceiver 212. When the controller 210 transmits commands to either the host transceiver 208 or the non-USB transceiver 212, it may perform signal amplifying and/or reshaping to compensate for the increased transmission path due to the extender 202. Further, the controller 210 also preferably determines the direction of each command or message so that the commands transmitted from the controller 210 are transmitted in the correct direction.

Turning next to FIG. 2C, a block diagram of the device unit 206 from FIG. 2A is illustrated. The device unit 206 includes a device transceiver 218, a controller 216, and a non-USB transceiver 214. Each of the device transceiver 218 and non-USB transceiver 214 may be a circuit implementing the physical layer for the transmission protocol. For example, the device transceiver 218 may be a USB 2.0 PHY or the like, while the non-USB transceiver 214 may be an Ethernet PHY, or the like. The device transceiver 218 is connectable to a device 106 via a USB cable 103 and is configured to receive from the device 106 standard USB commands and/or non-standard USB commands and transmit them to the controller 216. The device transceiver 218 may be a “host type” transceiver in that to the device 106, it appears to be the host 104. The device transceiver 218 may also be configured to transmit to the device 106 standard and/or non-standard USB commands received from the controller 216.

The non-USB transceiver 214 is connectable to the host unit 204 via the non-USB communications channel 205. The non-USB transceiver 214 is configured to receive non-USB commands from the host unit 204 via the non-USB communications channel 205 and transmit the received non-USB commands to the controller 216. The non-USB transceiver 214 may also be configured to receive non-USB commands from the controller 216 and transmit the received commands to the host unit 204 via the non-USB communications channel 205.

The device transceiver 218 and the non-USB transceiver 214 are each connected to the controller 216 by an interface. The interface 207 that connects the device transceiver 218 to the controller 216 may be, for example, a transceiver macrocell interface like the USB 2.0 Transceiver Macrocell Interface (UTMI). Similarly, the interface 209 that connects the non-USB transceiver 214 to the controller 216 may be, for example, one or both of a GigaBit Media Independent Interface (GMII) and a Ten Bit Interface (TBI).

The controller 216 may be a programmable circuit, such as a complex programmable logic device or the like. The controller 216 is configured to determine the nature of standard and/or non-standard USB commands received from the device transceiver 218, to convert the USB commands to non-USB commands, and to transmit the converted non-USB commands to the non-USB transceiver 214. The controller 216 may also be configured to determine the nature of the non-USB commands received at the non-USB transceiver 214, to convert the non-USB commands to standard and/or non-standard USB commands, and to transmit the converted commands to the device transceiver 218. When the controller 216 transmits commands to either the device transceiver 218 or the non-USB transceiver 214, it may perform signal amplifying and/or reshaping to compensate for the increased transmission path due to the extender 202. Further, the controller 216 also preferably determines the direction of each command or message so that the commands transmitted from the controller 216 are transmitted in the correct direction.

The extender 202 may also have a hub on the device side. The hub may be connected to the device unit 206 or incorporated into the device unit 206. The hub functions to allow the extender 202 to accept USB commands from multiple devices 106. In this embodiment, the controller 216 may be configured to determine the device 106 from which USB commands are received, or the device 106 to which USB commands are to be sent. Such determination may also be made elsewhere in the device unit 106 or in the hub.

One feature of USB technology is the capability to dynamically attach and detach devices (hot-plugging). To extend this feature over the non-USB channel 205 the extender 202 detects the disconnection of the non-USB channel 205 and simulates an electrical disconnect for the host 104. When the non-USB channel 205 is connected again the extender 202 simulates a “connect” to the host 104. When using CAT5 cable as the non-USB communications channel, this simulation is fairly simple. This functionality may be implemented automatically by powering the host unit 204 by the device unit 206 through the CAT5 cable, so removing the CAT5 cable means removing the power.

In one example embodiment, the extender 202 also includes circuitry for determining whether the host 104 is powered down and circuitry to determine if a power button located on a Mac keyboard device 106 has been pressed. This circuitry may or may not be part of one or both of the controllers 210 and 216. While the host 104 is powered down, the extender 202 can maintain a voltage of about 0.7V to about 1V. The extender 202 can also include circuitry for grounding, shunting, or shorting the maintained voltage circuit upon determining that the host 104 is powered down and the power button located on the Mac keyboard device 106 has been pressed.

In one example embodiment, the extender 202 includes circuitry for implementing reset, suspend, and wake-up functions for a Sun Microsystems host 104 and device 106. Again, this circuitry may or may not be part of one or both of the controllers 210 and 216.

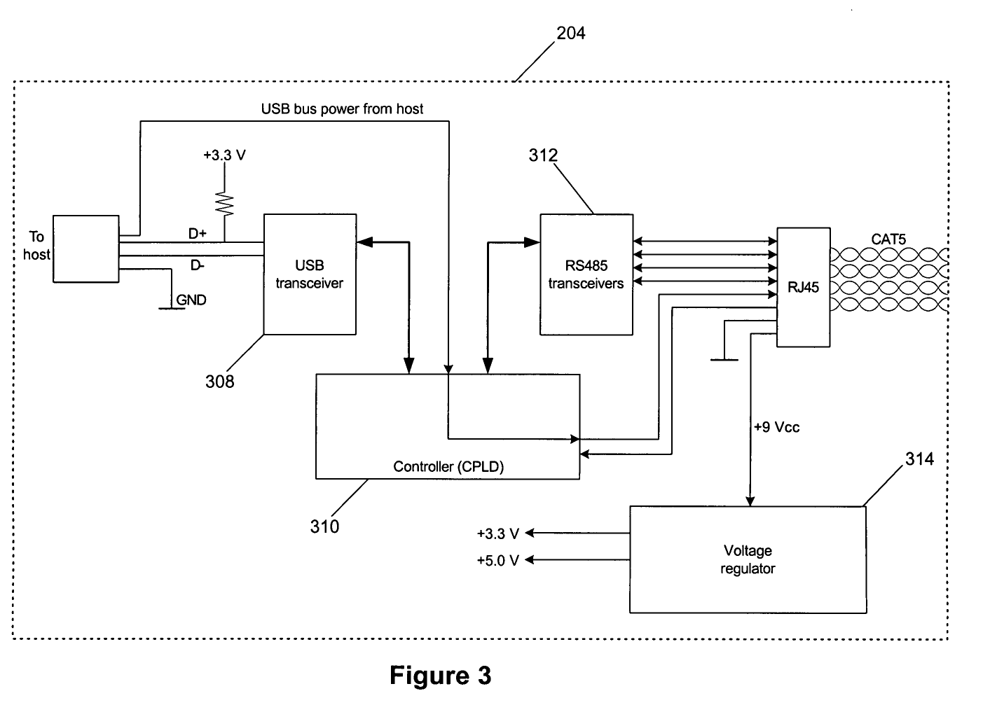

Turning to FIG. 3 an example embodiment schematic diagram of a host unit 204 implementing Mac keyboard functionality is provided. The host unit 204 includes a host transceiver 308, a controller 310, and a non-USB transceiver 312. The host transceiver 308 may be a USB PHY or the like, while the non-USB transceiver 312 may be an Ethernet PHY or the like (e.g., an RS485 transceiver). An RS485 communications channel provides a non-USB communications channel. RS485 is useful as a non-USB communications channel because it meets the requirements for a truly multi-point communications network and can withstand “data collisions” (bus contention problems) and bus fault conditions. Further, RS485 hardware can detect the start-bit of the transmission and automatically enable (on the fly) the RS485 transmitter. Once a character is sent the hardware can revert back into a receive mode within about 1-2 microseconds. Any number of characters can be sent, and an RS485 transmitter is capable of automatically re-triggering with each new character. In addition, a bit-oriented timing scheme can be used in conjunction with network biasing for fully automatic operation with a communications specification. Because delays are not required, the extender 202 may be capable of longer data transmission (and thus longer extensions) than if other non-USB communications channels were utilized.

The host transceiver 308 is connectable to a host 104 (FIGS. 1 and 2) via a USB cable 103 (FIGS. 1 and 2A) and is configured to transmit to the host 104 standard USB commands and/or non-standard USB commands received from the controller 310. The host transceiver 308 may be considered a “device type” transceiver since, to the host 104, the host transceiver 308 appears to be the device 106. The host transceiver 308 may also be configured to receive standard and/or non-standard USB commands from the host 104 and to transmit the received commands to the controller 310.

The non-USB transceiver 312 is connectable to the device unit 206 via the non-USB communications channel 205. The non-USB transceiver 312 is configured to receive non-USB commands from the device unit 206 via the non-USB communications channel 205 and transmit the received non-USB commands to the controller 310. The non-USB transceiver 312 may also be configured to receive non-USB commands from the controller 310 and transmit the received commands to the device unit 206 via the non-USB communications channel 205.

The controller 310 may be a programmable circuit, such as a complex programmable logic device or the like. The controller 310 is configured to determine the nature of the non-USB commands received at the non-USB transceiver 312, to convert the non-USB commands to standard and/or non-standard USB commands, and to transmit the converted commands to the host transceiver 308. The controller 310 may also be configured to determine the nature of standard and/or non-standard USB commands received from the host transceiver 308, to convert the USB commands to non-USB commands, and to transmit the converted non-USB commands to the non-USB transceiver 312. When the controller 310 transmits commands to either the host transceiver 308 or the non-USB transceiver 312, it may perform signal amplifying and/or reshaping to compensate for the increased transmission path due to the extender 202. Further, the controller 310 also preferably determines the direction of each command or message so that the commands transmitted from the controller 310 are transmitted in the correct direction.

The controller 310 has circuitry for detecting the status of the host 104. Such circuitry functions as a host power status detector. The controller 310 functions to detect the start and the end of the messages/commands and to control (start and stop) the transceivers 308 and 312. When there is no incoming communication from the host 104 to the transceiver 308 or from the device unit 206 to the transceiver 312 (referred to as ‘line idle’), the drivers of both transceivers 308 and 312 are disabled and the receivers enabled, allowing the controller 310 to listen for incoming communication from both directions. When a message/command starts from one direction, the controller 310 will enable the driver of transceiver 308 or 312 in the opposite direction to open the path for the message. When the message ends the controller will again, disable the drivers of the transceiver 308 or 312 and enable the receivers. The operation restarts with line idle.

Because the shape of the signal can be distorted by the extended travel path, the controller 310 may also function to correct signal distortion. When the first message is sent (following line idle), it reaches the controller 310 and the input of the transceiver 308 or 312 the same time. It may take about 20 ns for the controller 310 to detect the message and enable the transceiver 308 or 312. Consequently, the first bit (a synchronization bit) may be about 40 ns shorter after passing through the extender 202. To compensate, the signal may be delayed by the controller 310 before it reaches the input of the transceivers 308 and 312.

The host unit 204 also has a voltage regulator 314 for controlling voltage. For example, the voltage regulator 314 may function to maintain a voltage of about 0.7V to about 1V when the host 104 is powered down.

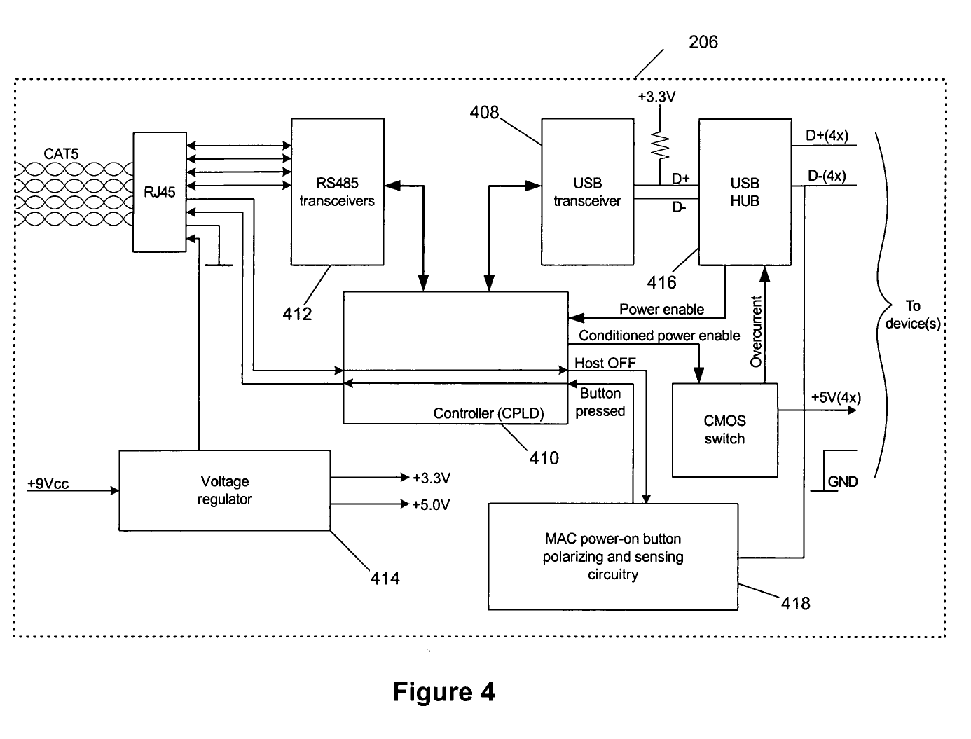

Turning now to FIG. 4, an example schematic diagram of a device unit 206 implementing Mac functionality is provided. The device unit 206 functions much the same way as does the host unit 204. Like the host unit 204, the device unit 206 has a USB transceiver 408, a controller 410, a non-USB transceiver 412, and a voltage regulator 414. Unlike the host unit 204, however, the device unit 206 also includes a hub 416. The hub 416 enables full speed signaling of messages through the extender 202, even if all the devices connected to the extender are low speed. However, the hub 416 can disrupt signal timing because the delay introduced by the hub 416 may be equivalent to about 5 meters of cable.

The device unit 206 also has Mac power-on sensing circuitry 418 to enable Mac keyboards 106 to turn on a powered down Mac host 104. When a Mac host 104 is turned off, the Mac host 104 cuts the power for the Mac keyboard 106, but maintains one of the communication lines (e.g., D−) at about 0.7V to about 1V. It is believed that the current drawn on the communication line (e.g., D−) will be very low. In the power down state, the Mac keyboard 106 configures the circuitry of the power-on button. In one embodiment, the power-on button is configured during the Mac host lower power mode as a temporary single pole single throw switch with a first terminal connected to the D− line and a second terminal connected to a ground (GND) line. When the user presses the power-on button, the button temporarily shorts or otherwise couples D− to ground. The Mac host 104 senses the voltage change of D− and turns on when D− is below about 0.3V. When the Mac host 104, and thus the Mac keyboard 106, are powered, the power-on button works like any other key by generating a code when pressed, in this case a shut down command. Both the coupling to ground and the shut down commands are non-standard USB commands.

The device unit 206 is therefore capable of maintaining the communication line (D−) at about 0.7V to about 1V using a very low current when the Mac host 104 is in a lower power mode. When the power-on button is pressed on the Mac keyboard 106, the Mac sensing circuitry 418 senses the change in the D− line and communicates the non-standard USB command to the controller 410 (e.g., generates and transmits an appropriate signal or data packet). In turn, the controller 410 couples the communication line (D−) of the host unit 204 to ground, which is detected by the Mac host 104 to turn on the Mac host 104. Therefore, the functionality of the host unit 204 and the device unit 206 transparently enable use of the Mac keyboard 106 power button as if the extender 202 were not present. When the power-on button is pressed on the Mac keyboard 106 when the Mac host 104 is not in a lower power mode, the non-standard USB shut down command is communicated through the extender 202 like any other command.

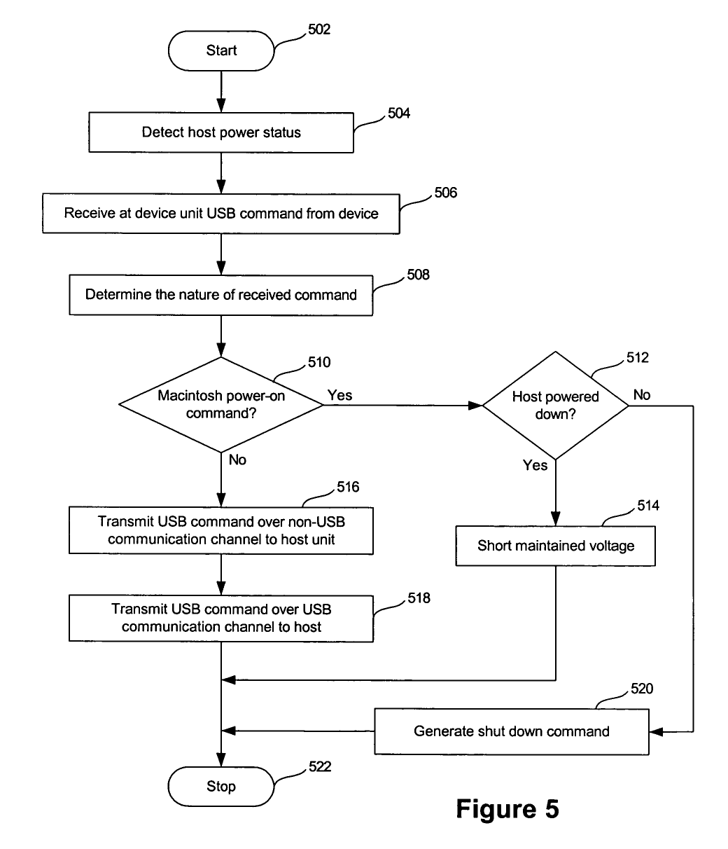

Turning next to FIG. 5, a flow chart generally illustrating an aspect of extending the distance between a Mac host 104 and a Mac keyboard device 106 that uses non-standard USB commands is provided. The basic flow commences at start block 502, from which progress is made to process block 504. At process block 504, the Mac host 104 power status is detected.

Progression then continues to process block 506 wherein a USB command is received by the extender 102 or 202 from the device 106. In one embodiment, the USB command is received by the device unit 206. The USB command may be a standard and/or non-standard USB command. Flow then progresses to process block 508 wherein the nature of the USB command is determined.

Flow then continues to decision block 510 wherein a determination is made whether the USB command is a Mac power command. A positive determination at decision block 510 causes progression decision block 512 wherein a determination is made whether the Mac host 104 is powered down, meaning that it is in a lower power mode.

A negative determination at decision block 512 causes progression to process block 520, wherein a shut down command is generated, after which progression continues to termination block 522.

A positive determination at decision block 512 causes progression to process block 514 wherein a circuit maintaining a voltage from the Mac host 104 to the Mac keyboard 106 is shorted, shunted or otherwise coupled to ground or other potential indicating a change in logical state. Progression then continues to termination block 522. It should be noted that the change in maintained voltage can also be considered a USB command, which in turn would be transmitted to the host unit 204. Accordingly, progression also could flow from process block 514 to process block 516.

A positive determination at decision block 510 causes progression to process block 516 wherein the USB command is transmitted over a non-USB communication channel to the host unit 204. Flow then continues to process block 518 wherein the USB command is transmitted over a USB communication channel to the Mac host 104, after which progression continues to termination block 522.

While the present invention has been described in association with several exemplary embodiments, the described embodiments are to be considered in all respects as illustrative and not restrictive. Such other features, aspects, variations, modifications, and substitution of equivalents may be made without departing from the spirit and scope of this invention which is intended to be limited solely by the scope of the following claims. Also, it will be appreciated that features and parts illustrated in one embodiment may be used, or may be applicable, in the same or in a similar way in other embodiments.

1. A USB extender for extending the distance between a host and a device, the USB extender comprising:
a controller;
a host transceiver connectable to a USB host and configured to transmit to the USB host both standard USB commands and non-standard USB commands received from the controller; and
a device transceiver connectable to a USB device and configured to receive both standard USB commands and non-standard USB commands from the USB device and to transmit the received USB commands to the controller;
wherein the controller is configured to determine the nature of the USB commands received at the device transceiver and to transmit determined commands to the host transceiver.

2. The USB extender of claim 1 wherein the host transceiver is further configured to receive USB commands from the host and to transmit the received USB commands to the controller.

3. The USB extender of claim 2 wherein the device transceiver is further configured to transmit to the device USB commands received from the controller.

4. The USB extender of claim 3 wherein the controller is further configured to determine the nature of the USB commands received at the host transceiver and to transmit determined commands to the device transceiver.

5. A USB extender for extending the distance between a host and a device, the USB extender comprising:
a host unit connectable to a USB host and configured to transmit to the host both standard USB commands and non-standard USB commands received from a device unit via a non-USB communications channel;
a device unit connectable to a USB device and configured to receive both standard USB commands and non-standard USB commands from the USB device and transmit the received commands to the host unit via the non-USB communications channel; and
a non-USB communications channel between the host unit and the device unit.

6. The USB extender of claim 5 wherein at least one non-standard USB command received by the device unit from the device is a Mac power-on command.

7. The USB extender of claim 6 wherein the host unit comprises a host power status detector.

8. The USB extender of claim 7 wherein the USB extender is configured to maintain a voltage from the host to the USB device when the host is in a lower power mode and wherein the USB extender is configured to create a change in a maintained voltage when the device unit receives Mac power-on command.

9. The USB extender of claim 8 wherein the maintained voltage is about 0.7 volts to about 1 volt.

10. The USB extender of claim 5 wherein at least one non-standard USB command received by the device unit from the device is a SUN power management command.

11. The USB extender of claim 5 wherein the host unit and device unit each comprise a USB to non-USB signal converter for converting USB signals to non-USB signals and a non-USB to USB signal converter for converting non-USB signals to USB signals.

12. The USB extender of claim 11 wherein the non-USB to USB signal converter and USB to non-USB signal converter are the same signal converter.

13. The USB extender of claim 5 wherein the host unit and device unit each comprise a voltage regulator for regulating voltage from the host to the USB device.

14. The USB extender of claim 5 further comprising a hub for accepting USB commands from multiple USB devices.

15. The USB extender of claim 14 wherein a device unit controller is configured to determine the device from which the USB commands are received.

16. The USB extender of claim 5 wherein the host unit is further configured to receive USB commands from a host and to transmit the received USB commands to the device unit via a non-USB communications channel.

17. The USB extender of claim 5 wherein the device unit is further configured to receive USB commands from a host unit via a non-USB communications channel and to transmit the received USB commands to the device.

18. The USB extender of claim 5 wherein the USB extender is compatible with at least one of USB 1.x and USB 2.x.

19. A method for extending the distance between a host and a Mac keyboard device that uses non-standard USB commands, the method comprising:
detecting the host power status by a host unit;
maintaining a voltage from the host to the keyboard when the host is powered down;
receiving a USB command from the keyboard at a USB extender device unit;
determining the nature of the command;
coupling the maintained voltage to ground upon determining that the host is powered down and the received command is a Mac power-on command;
transmitting the received USB command from the USB extender device unit over a non-USB communications channel to a USB extender host unit; and
transmitting the USB command received at the USB extender host unit to the host over a USB communications channel.

20. The method of claim 16 further comprising responding to a request from a host with a not acknowledge command and sending the request to the USB device.
